(19) United States
(12) Patent Application Publication
(10) Pub. No.: US 2020/0342623 A1
(43) Pub. Date: Oct. 29, 2020

(54) SYSTEMS AND METHODS FOR RESOLVING HIDDEN FEATURES IN A FIELD OF VIEW

(71) Applicant: Apple Inc., Cupertino, CA (US)

(72) Inventors: Christy F. Cull, Sunnyvale, CA (US); Evan C. Cull, Sunnyvale, CA (US)

(21) Appl. No.: 16/856,465

(22) Filed: Apr. 23, 2020

Related U.S. Application Data
(60) Provisional application No. 62/837,609, filed on Apr. 23, 2019.

(51) Int. Cl. G06T 7/73; B60W 30/09; B60W 50/14

(52) U.S. Cl. CPC G06T 7/73; B60W 30/09; B60W 50/14; B60W 2720/10; G06T 2207/10048; B60W 2420/40; B60W 2710/30; G06T 2207/30261

(57) ABSTRACT

Implementations described and claimed herein provide systems and methods for object detection. In one implementation, thermal energy data in a long wavelength infrared band for a wide field of view is obtained. The thermal energy data is captured using at least one long wavelength infrared sensor of a sensor suite mounted to a vehicle. A foveated long wavelength infrared image is generated from the thermal energy data. The foveated long wavelength infrared image has a higher resolution concentrated in a designated region of the wide field of view and a lower resolution in a remaining region of the wide field of view. Emissivity and temperature data for the designated region is obtained by processing the foveated long wavelength infrared image. One or more features in the designated region are resolved using the emissivity and temperature data.

### CROSS-REFERENCE TO RELATED APPLICATIONS

The present application claims priority to U.S. Provisional Application No. 62/837,609, entitled “Systems and Methods for Resolving Hidden Features in a Field of View” and filed on Apr. 23, 2019, which is incorporated by reference herein in its entirety.

### FIELD

Aspects of the present disclosure relate to object detection and more particularly to long wavelength infrared foveated vision for resolving objects with diminished visibility in a wide field of view for a vehicle.

### BACKGROUND

Objects along a travel path of a vehicle, particularly moving objects, such as animals, that intersect the travel path of the vehicle, are challenging to avoid. Autonomous or semi-autonomous vehicles may include various sensor systems for object detection for driver assistance in avoiding such objects. However, conventional sensor systems often fail in adverse light conditions, including nighttime, low visibility weather (e.g., fog, snow, rain, etc.), glare, and/or the like that obscure or diminish the visibility of such objects. For example, monochromatic sensors generally require active illumination to detect objects in low light conditions and are prone to saturation during glare. As such, objects remain hidden from detection by monochromatic sensors in low light conditions and in the presence of glare, for example, due to external light sources, such as the headlights of other vehicles. Other conventional sensor systems eliminate the need for active illumination by using passive sensors, such as long wavelength infrared sensors. However, such sensor systems typically fail to identify objects in adverse light conditions due to low resolution. Many other conventional sensor systems are cost, weight, and/or size prohibitive for deployment into a vehicle for object detection. Accordingly, objects remain hidden from conventional sensor systems in adverse light conditions, thereby exacerbating the challenge of avoiding such objects. It is with these observations in mind, among others, that various aspects of the present disclosure were conceived and developed.

### SUMMARY

Implementations described and claimed herein address the foregoing issues by providing systems and methods for object detection. In one implementation, thermal energy data in a long wavelength infrared band for a wide field of view is obtained. The thermal energy data is captured using at least one long wavelength infrared sensor of a sensor suite mounted to a vehicle. A foveated long wavelength infrared image is generated from the thermal energy data. The foveated long wavelength infrared image has a higher resolution concentrated in a designated region of the wide field of view and a lower resolution in a remaining region of the wide field of view. Emissivity and temperature data for the designated region is obtained by processing the foveated long wavelength infrared image. One or more features in the designated region are resolved using the emissivity and temperature data.

In another implementation, a sensor suite is mounted to a vehicle. The sensor suite has a plurality of sensors including at least one long wavelength infrared sensor. The at least one long wavelength infrared sensor captures thermal energy in a long wavelength infrared band for a wide field of view. An image signal processor resolves an object with diminished visibility in the wide field of view using emissivity and temperature data obtained from a foveated long wavelength infrared image. The foveated long wavelength infrared image has a higher resolution concentrated in a designated region of the wide field of view and a lower resolution in a remaining region of the wide field of view. The designated region includes the object.

In yet another implementation, thermal energy data in a long wavelength infrared band for a wide field of view is obtained. A foveated long wavelength infrared image is generated from the thermal energy data. The foveated long wavelength infrared image has a higher resolution concentrated in a designated region of the wide field of view and a lower resolution in a remaining region of the wide field of view. A presence of an object with diminished visibility is detected based on at least one of emissivity or temperature of the thermal energy data exceeding a threshold in the designated region. The object is identified based on a thermal profile generated from the thermal energy data.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example sensor suite providing long wavelength infrared foveated vision with higher resolution located at a center of a wide field of view.

FIG. 2 depicts an example long wavelength infrared foveated image having a designated region having higher resolution located at a center.

FIG. 3 shows an example sensor suite providing long wavelength infrared foveated vision with higher resolution located at extremities of a wide field of view.

FIG. 4 illustrates an example long wavelength infrared foveated image having a designated region having higher resolution located at extremities.

FIG. 5 shows an example sensor suite maximizing a field of view while maintaining spatial resolution.

FIG. 6 illustrates an example long wavelength infrared image with a wide field of view with spatial resolution.

FIGS. 7A and 7B illustrate an example field of view for long wavelength infrared foveated vision.

FIG. 8 depicts an example front longitudinal far field of view for long wavelength infrared foveated vision.

FIG. 9 shows an example rear longitudinal far field of view for long wavelength infrared foveated vision.

FIG. 10 illustrates an example front cross traffic field of view for long wavelength infrared foveated vision.

FIG. 11 depicts an example rear cross traffic field of view for long wavelength infrared foveated vision.

FIG. 12 shows an example sensor suite providing long wavelength infrared foveated vision with extended depth of field.

FIG. 13 shows an example fusing of long wavelength infrared foveated images to generate extended depth of field.

FIG. 14 illustrates example operations for object detection.

FIG. 15 is a functional block diagram of an electronic device including operational units arranged to perform various operations of the presently disclosed technology.

FIG. 16 is an example computing system that may implement various systems and methods of the presently disclosed technology.

### DETAILED DESCRIPTION

Aspects of the present disclosure provide autonomy for a vehicle in adverse light conditions, such as nighttime, low visibility weather (e.g., fog, snow, rain, etc.), low light conditions, glare, and/or the like that obscure or diminish the visibility of objects. For example, disparate nighttime environments have differing degrees of ambient light, which impacts a sensitivity of a sensor suite of the vehicle used to detect objects. A city environment typically has abundant ambient light from street lamps, adjacent buildings, city congestions, and the like. Meanwhile, a rural environment has limited ambient light that originates primarily from starlight, moonlight, and airglow. In between these environments, a suburban environment has ambient light from street lamps, housing, and vehicular traffic.

Objects may be hidden from detection in the field of view for a vehicle during such adverse light conditions. For example, a mammal, such as a deer, may be not be visible at a side of the street in the dark and dart across the street as the vehicle approaches. Due to the thermal signature of such objects, long wavelength infrared (LWIR) vision permits objects to be detected at various distances from the vehicle in adverse light conditions. However, LWIR typically suffers from a narrow field of view and poor resolution, such that objects may remain hidden from detection depending on where they are located relative to the vehicle. Thus, the presently disclosed technology concentrates resolution of LWIR vision at designated regions in the field of view to detect and identify objects that are otherwise hidden from detection.

By using such LWIR foveated vision, thermal energy for objects may be detected at higher resolution in a designated region of a wide field of view in which hidden objects may be located. Additionally, an extended depth of field may be created to obtain additional detail about the hidden objects in the designated region using multiple LWIR images through stereo vision. The distance to the object is determined by extending a range of distance over which the object remains in focus. Finally, the LWIR foveated vision may be used in combination with other imaging and/or detection systems, including monochromatic sensors, red/green/blue (RGB) sensors, light detection and ranging (LIDAR) sensors, and/or the like for enhanced object detection.

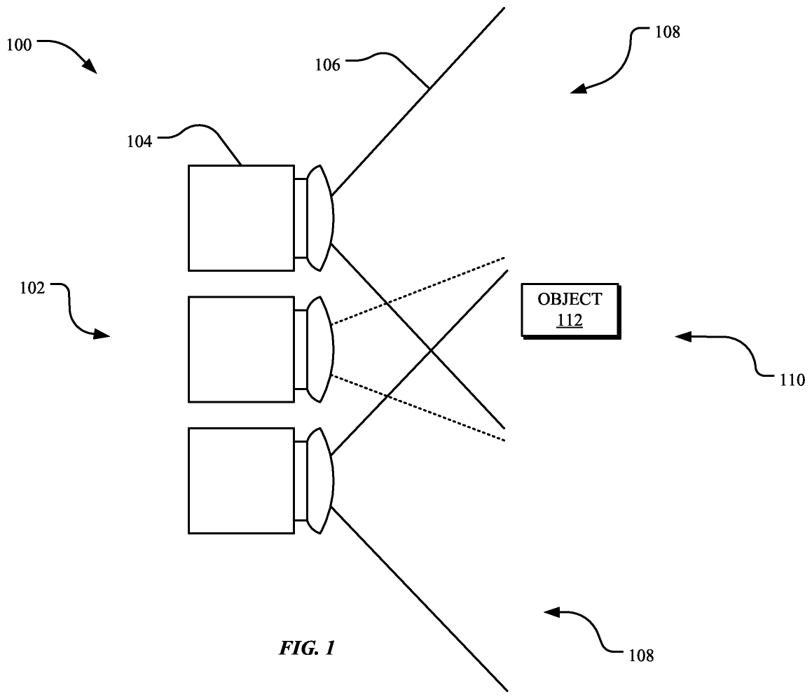

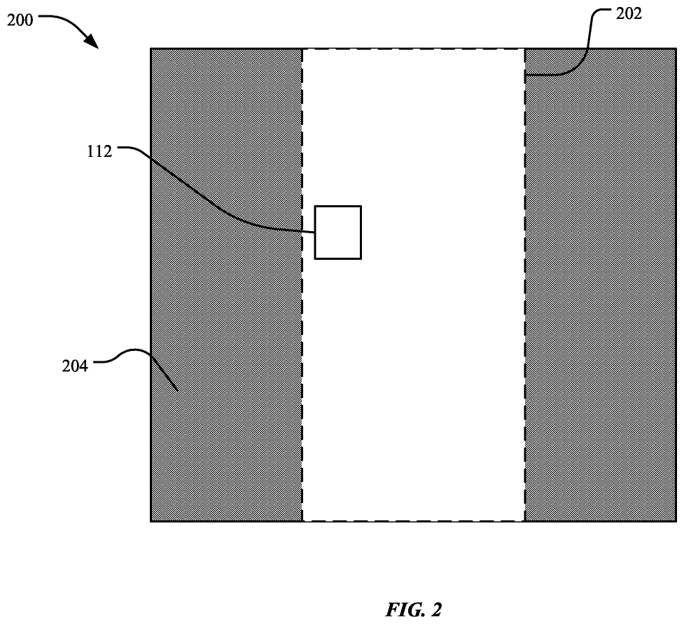

Referring first to FIGS. 1-2, an example sensor suite 102 of an object detection system 100 is illustrated. In one implementation, the sensor suite 102 includes a plurality of sensors 104 with a dedicated aperture adapted to capture image data of an external environment of a vehicle. The sensor suite 102 may be mounted to the vehicle at various locations, such as a bumper, grill, and/or other locations on or within the vehicle.

Each of the sensors 104 has a sensor field of view 106 that collectively generate an overall field of view of the external environment in which an object 112 is present. The overall field of view is a wide field of view including a center 110 disposed between extremities 108. The object detection system 100 provides LWIR foveated vision for perception and object resolution in short or long range in adverse light conditions. As shown in FIGS. 1-2, the object detection system 100 provides a wide field of view mapping with a highest resolution concentrated at the center 110 from which a foveated LWIR image 200 is generated. The foveated LWIR image 200 includes a designated region 202 at a center of the foveated LWIR image 200 and a remaining region 204 at a periphery of the foveated LWIR image 200. The designated region 202 has a higher resolution corresponding to the center 110 of the overall field of view, and the remaining region 204 has a lower resolution corresponding to the extremities 108 of the overall field of view. Using the increased resolution of the designated region 204, the object 112 may be detected and identified.

More particularly, the plurality of sensors 104 includes at least one LWIR sensor, which may be married to an RGB sensor and/or other sensors. Each of the sensors 104 may include thin optical elements and a detector, including a digital signal processor (DSP), which converts voltages of the thermal energy captured with the sensors 104 into pixels of thermal energy data, and image signal processor (ISP) that generates the foveated LWIR image 200 from the thermal energy data, and/or the like. In one implementation, each of the sensors 104 are co-boresight, thereby providing enhanced object detection. For example, LWIR sensor(s) may be aligned to a same optical axis as RGB sensor(s) to provide an instantaneous field of view between them. In this case, one pixel in LWIR may map to a two by two grid in RGB, as a non-limiting example, such that one may be downsampled to the resolution of the other. As can be understood from FIG. 1, the sensor suite 102 may utilize a tri-aperture foveated approach to provide an overlap between the sensors 104 having a long effective focal length (LEFL) and the sensors 104 with a short effective focal length (SEFL) in LWIR. The SEFL may correspond to a wide-angle lens, for example with a focal length of approximately 35 mm or less for a 35 mm-format sensor. The LELF may correspond to a telephoto lens, for example with a focal length of approximately 85 mm or more for a 35 mm-format sensor.

Generally, the LWIR sensors of the sensors 104 passively capture thermal energy data from which emissivity and temperature of the object 112 may be determined. The emissivity of the surface of a body is its effectiveness in emitting energy as thermal radiation. Infrared emissions from an object are directly related to the temperature of the object. More particularly, emissivity is the ratio, varying from 0 to 1, of the thermal radiation from a surface of an object to the radiation from a perfect black body surface at the same temperature. For example, hotter objects emit more energy in the infrared spectrum than colder objects. Mammals, as well as other moving or static objects of interest, are normally warmer than the surrounding environment. Since targets, such as the object 112, emit more infrared energy than the surrounding environment in the overall field of view, the LWIR sensors capture the thermal energy emitted by the object 112 in the LWIR band, which is ideal for near room temperature objects, and the object detection system 100 detects and identifies the object 112.

Stated differently, due to the emissivity and temperature of the object 112 independent of light conditions in the surrounding environment, the sensors 104 passively capture thermal energy in the LWIR frequency, from which the object 112 may be detected and identified during adverse light conditions. LWIR has a peak temperature value for detection at approximately room temperature, which provides a transmission window for object detection during adverse light conditions, such as nighttime and low visibility weather, such as fog, snow, rain, and/or the like. For example, relative to other frequencies, LWIR provides optimized atmospheric transmission for fog penetration for both advective and radiative fog mediums. Additionally, due to the emissivity of targets, such as the object 112, the sensors 104 may capture thermal energy data for the object 112 at near distances from the vehicle, as well as far distances from the vehicle, for example, at a range of approximately 200 meters.

Capturing thermal energy data in the LWIR band enables the object detection system 100 to resolve targets, such as the object 112, in various imaging applications. For example, the object detection system 100 may use the thermal energy data in the LWIR frequency in: thermal emission contrasting, for example, to generate a high contrast image distinguishing between hotter and colder objects; obstacle detection distinguishing between those objects which may be an obstacle along a travel path of the vehicle and those that are not; daytime image contrasting to perceive objects in more detail that appear saturated when observed using other sensors 104, such as a RGB sensor (e.g., using a composite of an RGB image and a LWIR image); and anti-glare applications to perceive objects obscured by glare, for example, originating from headlights of oncoming traffic, reflections of sunlight off surfaces, and/or other light sources.

Despite the obvious advantages of LWIR sensing, LWIR is not conventionally utilized in object detection, as it generally is low resolution and has a narrow field of view. Thus, the sensor suite 102 combines higher resolution sensors with lower resolution sensors to generate a wide field of view, and one or more ISPs concentrates the higher resolution at the designated region 202 to detect and identify the object 112 located therein. Stated differently, the sensor suite 102 includes a multi-sensor configuration enabling autonomy in adverse light conditions by capturing thermal energy in the LWIR band and compensating for a lack of spatial resolution in LWIR through a foveated approach.

The sensor suite 102 thereby acquires wide field of view and high dynamic range LWIR images with high-resolution concentrated in region(s) of the field of view where targets may be present. While field of view, resolution, and depth of field of conventional sensors are limited according to the corresponding optics, a foveated approach overlaps the sensor field of view 106 of one or more of the sensors 104 to capture a wide visual field with a dynamically embedded, high-resolution designated region 202. In one implementation, peripheral sensors of the sensors 104 disposed at the extremities 108 of the wide field of view capture context for detection and tracking of the object 112 in lower resolution, and foveated sensors of the sensors 104 located at the center 110 of the wide field of view provide a resolution many magnitudes greater than the peripheral sensors, thereby capturing the fine details for recognition and detailed examination of the object 112. Stated differently, the ISP(s) of the object detection system 100 generate the foveated LWIR image 200 through image processing in which the image resolution, or amount of detail, varies across the foveated LWIR image 200 according to one or more fixation points associated with the designated region 202. The fixation points thus indicate the highest resolution region of the foveated LWIR image 200. The fixation points may be configured automatically, for example, based on the relationship of the sensor field of views 106 and/or the optics of the sensors 104.

In one implementation, the sensors 104 include a plurality of SEFL lenses to provide a longer depth of field and at least one LEFL lens to provide a foveated approach. As such, the object detection system 100 directs higher resolution to the designated region 202, which in the example shown in FIGS. 1-2 corresponds to the center 110 of the wide field of view. The object detection system 100 generates an overlap of the sensor field of views 106 to provide a wide field of view with higher resolution at the center 106 and a lower resolution at the extremities 108. However, the designated region 202 may be disposed at other areas, such as the extremities 108, as described herein. Using emissivity and temperature values extracted from the thermal energy data for the designated region 202, the ISP(s) of the object detection system 100 detect and identify the object 112.

In one implementation, the object detection system 100 determines that the object 112 is moving based on a change in a location or intensity of the emissivity and temperature values from the foveated LWIR image 200 to a second foveated LWIR image. Stated different, as the object 112 moves, the sensor suite 102 will capture thermal energy data corresponding to different locations within the field of view, resulting in a change between image frames. In addition or alternative to detecting a change between image frames, the object detection system 100 detects an object within the field of view based on temperature and emissivity data. More particularly, the object detection system 100 processes the foveated LWIR image 200 to obtain emissivity and temperature data within the designated region 202 from which a thermal profile for the object 112 may be generated.

More particularly, the ISP directs the higher resolution to the designated region 202 and generates the thermal profile for the object 112 based on the emissivity and temperature within the designated region 202. The thermal profile indicates a presence of the object 112 in the designated region 202. After such detection of the object 112, the object detection system 100 identifies the object 112. In one implementation, the object detection system 100 stores or otherwise obtains reference thermal profiles for a variety of objects at different distances, and through a comparison of the thermal profile for the object 112 with the reference thermal profiles, the object 112 is identified. For example, a pedestrian at a particular distance may exhibit certain thermal characteristics distinguishable from a pedestrian at another particular distance and from other object types, such that various thermal profiles for different objects at different distances may be generated for object identification and ranging. In another implementation, the sensor suite 102 is thermally calibrated with the reference thermal profiles or trained via machine learning to recognize a thermal profile of an object at a particular distance for object identification and ranging. For each pixel, a response of the thermal energy data captured by the sensors 104 will behave as a function of temperature, such that a thermal profile for the object 112 may be generated and analyzed to determine an object type of the object 112 and a distance of the object 112 from the vehicle. Because it is known where the higher resolution is in the designated region 202 and where the lower resolution is in the remaining region 204, a different amount of pixels may be used to identify and detect objects located at the center 110 than the extremities 108.

In identifying the object 112 using the thermal profile, in one implementation, the object detection system 100 analyzes a relationship of temperature and/or emissivity of the object 112 with a size of the object 112, a distance to the object 112, and/or the like. The thermal profile may include thermal parameters including emissivity, temperature, size, distance, and/or the like, which may be compared to reference parameters stored to provide different levels of discrimination of object identification. The object detection system 100 thus provides a fine tuned but coarse level resolution of hidden features in a wide field of view based on emissivity and temperature data.

In one example, the object detection system 100 may be used to perceive hidden features of the object 112 that are obscured by glare. For example, light may be emitted from headlights at the center 110 of the field of view, such that the object 112 has diminished visibility. While any RGB sensors or similar sensors of the sensor suite 102 will saturate in such adverse light conditions, the LWIR sensors provide an anti-glare approach. The RGB sensor, for example, includes a full well of a certain number of electrons, and at certain pixels the full well saturates in RGB in the presence of glare. On the other hand, LWIR provides a higher dynamic range. For example, headlights of vehicles are typically light emitting diode (LED) based or incandescent based, such that headlights are constrained to a certain frequency on the thermal spectrum. As such, the LWIR sensor not only does not saturate as a flux of thermal energy in watts per square meter is received through the dedicated aperture, the LWIR sensor is able to distinguish between the thermal profile of the headlights and the thermal profile of the object 112, thereby resolving hidden features of the object 112 that were otherwise obscured by the glare.

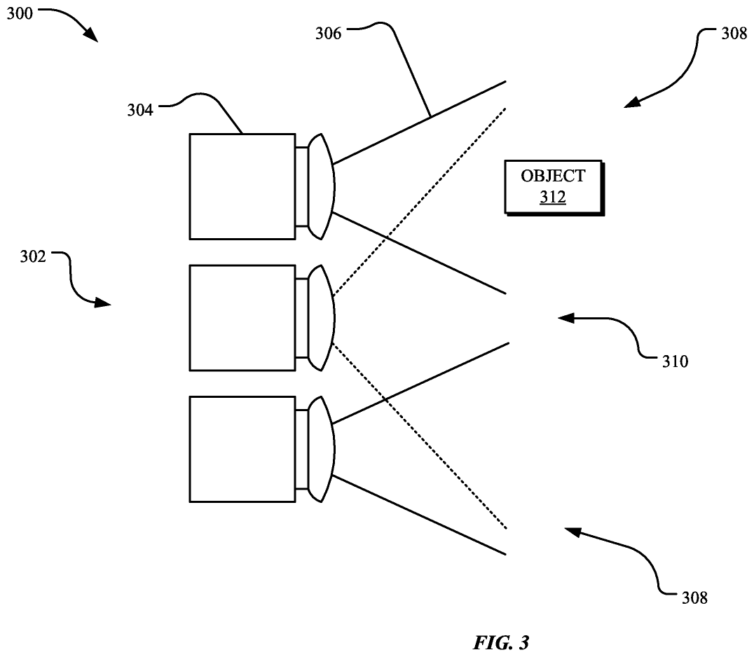

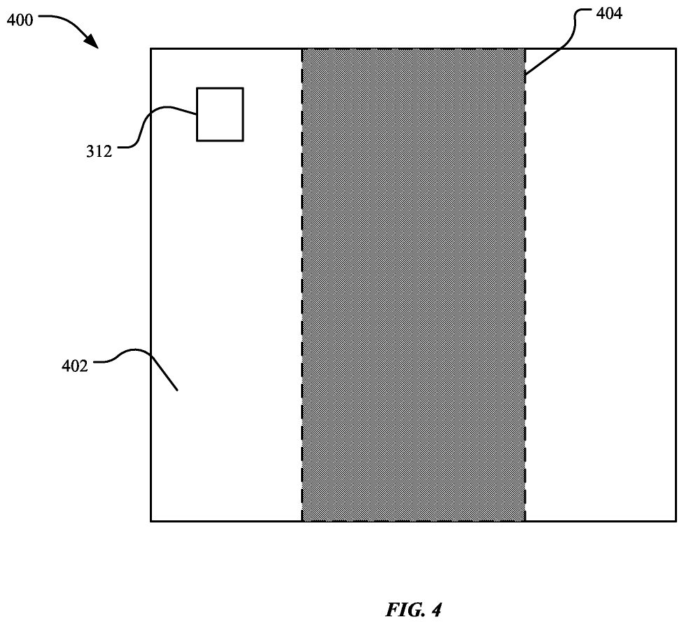

As described herein, the designated region may be at various locations within the field of view depending on where objects may have diminished visibility, and using programmable foveated LWIR vision. As shown in FIGS. 1-2, the foveated LWIR vision may provide wide field of view mapping with a higher resolution at a center of the field of view. As another example, the foveated LWIR vision may maintain a higher resolution at extremities of the field of view to maximize perception at the edges, for example, to detect objects, such as pedestrians, mammals, and/or the like at a side of a road, as shown in FIGS. 3-4.

Turning to FIGS. 3-4, an example sensor suite 302 of an object detection system 300 is illustrated. In one implementation, the sensor suite 302 includes a plurality of sensors 304. The various components of the object detection system 300 may be substantially the same as those described with respect to the object detection system 100. More particularly, like the object detection system 100, the object detection system 300 provides a multi-aperture sensor suite 302 optimized for cost, size, weight, and power that generates high contrast and high dynamic range for autonomy in adverse light conditions. One or more ISPs of the sensor suite 302 processes thermal energy data and extracts thermal parameters in a foveated approach.

Each of the sensors 304 has a sensor field of view 306 that collectively generate an overall field of view of the external environment in which an object 312 is present. The overall field of view is a wide field of view including a center 310 disposed between extremities 308. The object detection system 300 provides LWIR foveated vision for perception and object resolution in short or long range in adverse light conditions. As shown in FIGS. 3-4, the object detection system 300 provides a wide field of view mapping with a highest resolution concentrated at the extremities 308 from which a foveated LWIR image 400 is generated. The foveated LWIR image 400 includes a designated region 402 at a periphery of the foveated LWIR image 400 and a remaining region 404 at a center of the foveated LWIR image 400. The designated region 402 has a higher resolution corresponding to the extremities 308 of the overall field of view, and the remaining region 404 has a lower resolution corresponding to the center 310 of the overall field of view. Using the increased resolution of the designated region 404, the object 312 may be detected and identified.

As an example, the vehicle may be traveling along a travel path at night in a rural environment where the headlights may not illuminate the object 312 since it is located at the extremities 308 of the field of view. Using the foveated LWIR vision, the object detection system 300 detects the presence of the object 312 at the extremities 308, and identifies the object type of the object 312 (e.g., a deer) and a distance to the object 312. In one implementation, the object detection system 300 communicates the detection and identification of the object 312 to a vehicle controller of the vehicle which executes at least one vehicle operation in response. The vehicle operation may include, without limitation, presenting a notification of a presence of the object; controlling a direction of travel of the vehicle to avoid the object; slowing a speed of the vehicle; directing at least one light source towards the designated region to illuminate the object 312; and/or the like. For example, the notification may be a visual, audial, and/or tactile alert presented to a driver of the vehicle using a user interface. In one example, the object 312 is highlighted using a heads-up display (HUD) or via an augmented reality interface. The light source may be directed towards the object 312 through a cueing approach.

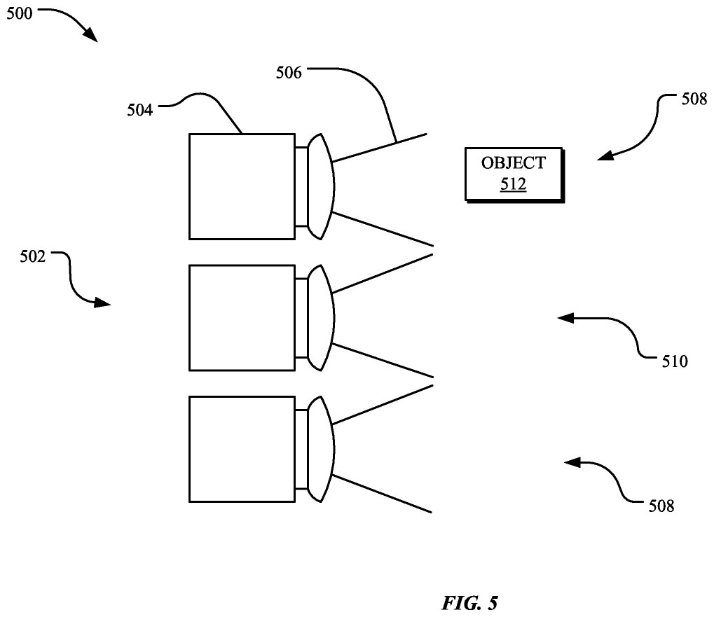

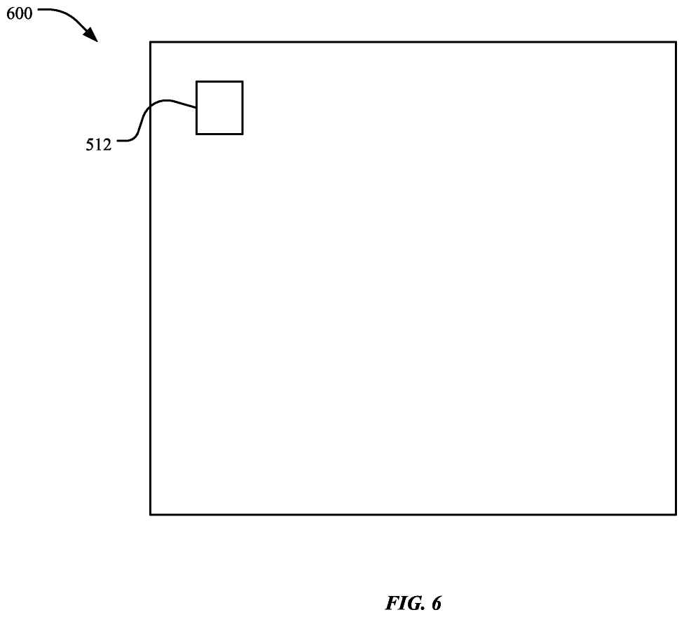

Conventionally, object detection systems have a field of view that suffers from low-resolution and degradation at edges where objects, such as mammals, pedestrians, and/or the like may be present. Thus, the foveated approach described with respect to FIGS. 3-4 may be used to maintain a high resolution at the extremities for object detection and identification. On the other hand, in one implementation, an example sensor suite 502 of an object detection system 500 includes a plurality of sensors 504. The various components of the object detection system 500 may be substantially the same as those described with respect to the object detection systems 100 and/or 300. More particularly, like the object detection system 100 and 300, the object detection system 500 provides a multi-aperture sensor suite 502 optimized for cost, size, weight, and power that generates high contrast and high dynamic range for autonomy in adverse light conditions. Each of the sensors 504 has a sensor field of view 506 that collectively generate an overall field of view of the external environment in which an object 512 is present. The overall field of view is a wide field of view including a center 510 disposed between extremities 508. The sensor suite 502 provides a multi-aperture approach to maximizing the field of view while maintaining spatial resolution. Thus, as shown in FIGS. 5-6, the object detection system 500 provides a wide field of view mapping while maintaining spatial at the extremities 508 as well as the center 510 from which a LWIR image 600 is generated. Thus, the object 512 may be detected and identified at various locations within the field of view during adverse light conditions and at short-to-long ranges.

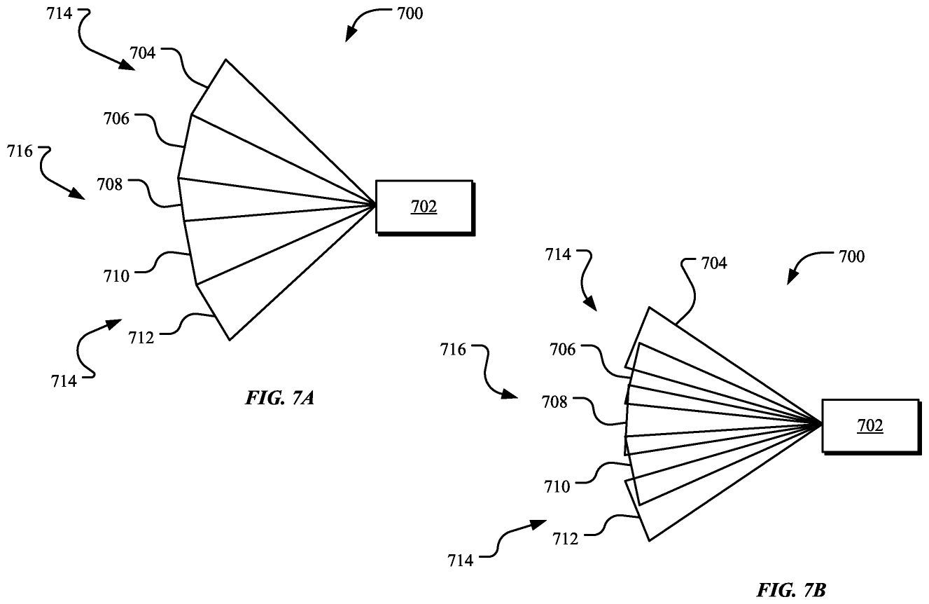

FIGS. 7A and 7B illustrate an example field of view 700 for LWIR foveated vision for a vehicle 702. As described herein, the presently disclosed technology provides programmable field of view optimization through a foveated approach. A sensor suite having a plurality of SEFL and LEFL lenses are deployed for the vehicle 702. Each corresponding sensor generates a sensor field of view 704-712 forming a wide field of view with a center 716 disposed between extremities 714. The sensor field of view 708 disposed at the center 716 may be a relatively smaller field of view, but due to the overlap of the sensor field of views 704-712 at the center 716, the wide field of view has a higher resolution at the center 716 and a lower resolution at the extremities 714. As detailed herein, this configuration may be changed to provide higher resolution at the extremities 714 and lower resolution at the center 716. In one non-limiting example, assuming sensors with 640×512 pixels, a pitch of 17 μm, and 14 bits, the sensor field of views 704, 706, 710, and 712 may be approximately 19 degrees with an effective focal length of 25, while the sensor field of view 708 may be approximately 14 degrees with an effective focal length of 35. The presently disclosed technology balances operation within disparate environments exhibiting different light levels, sensor sensitivity (e.g., quantum efficiency, NEI, pixel area, dynamic range, and integration time), and situational awareness (e.g., perception across a wide field of view).

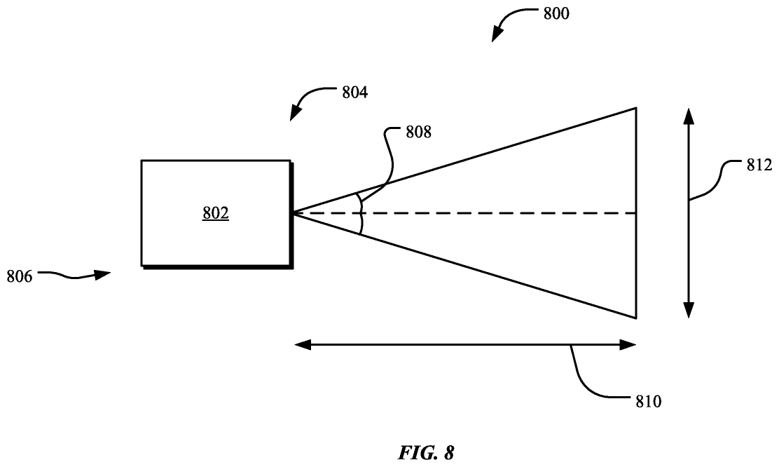

Turning to FIGS. 8-11, various configurations for LWIR foveated vision are illustrated. Such configurations may include different amounts of pixels on target, with the fields of view being a function of range. In each configuration, a type of field of view, a number of units, and a field of view per unit may be determined. The Johnson criteria for thermal imaging, which provides how many pixels are needed to have a 50-90% detection, recognition, and identification, may be used in these determinations as a metric for the foveated approach.

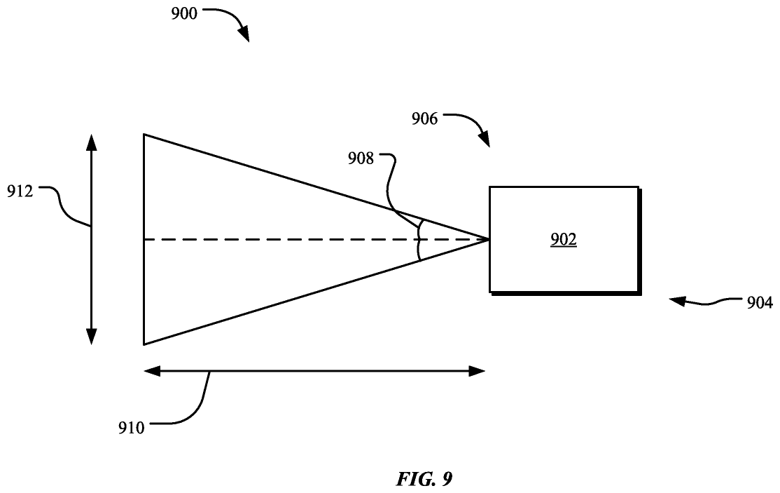

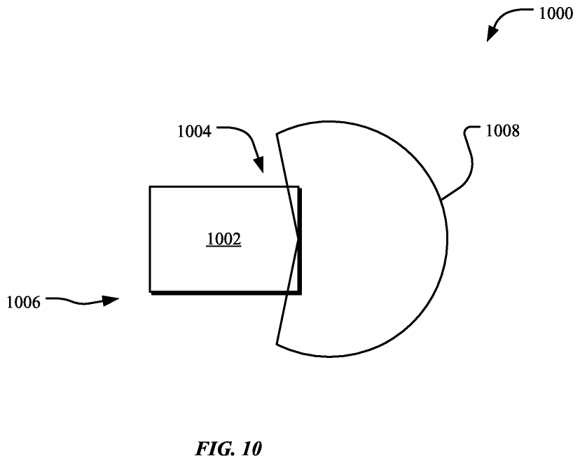

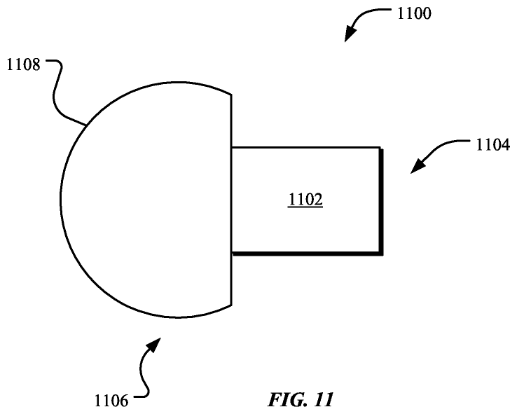

For example, FIG. 8 depicts an example longitudinal far field of view 800 directed from a front 804 of a vehicle 802 and away from the rear 806. The longitudinal far field of view 800 has a length 810 and a width 812 dictated by an angle 808 away from a center of the field of view 800. Similarly, FIG. 9 shows an example longitudinal far field of view 900 directed from a rear 906 of a vehicle 902 and away from the front 904. The longitudinal far field of view 900 has a length 910 and a width 912 dictated by an angle 908 away from a center of the field of view 900. FIG. 10 illustrates an example front cross traffic field of view 1000 directed from a front 1004 of a vehicle 1002 and away from the rear 1006. The cross traffic field of view 1000 has a shape 1008 providing coverage at a front and sides of the vehicle 1002. FIG. 11 depicts an example rear cross traffic field of view 1100 directed from a rear 1106 of a vehicle 1102 and away from the front 1104. The cross traffic field of view 1100 has a shape 1108 providing coverage at a rear of the vehicle 1002.

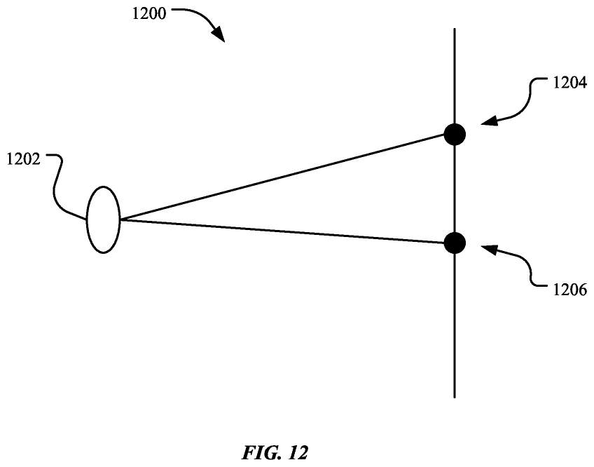

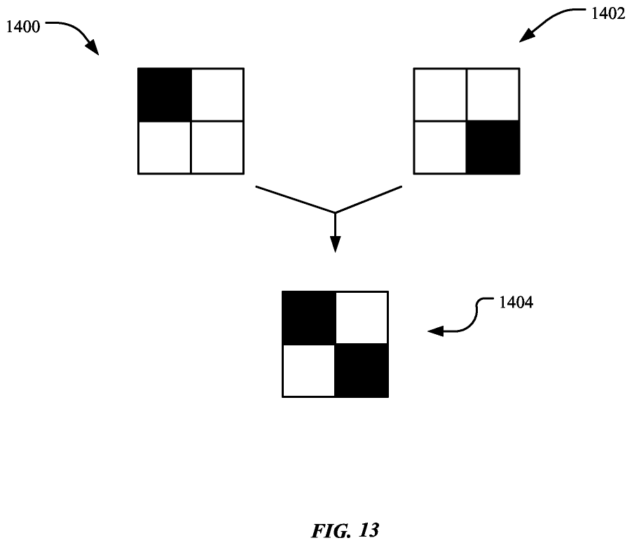

For a detailed description of LWIR foveated vision with an extended depth of field, which brings into focus targets that may have been mis-detected using a single sensor or for which otherwise additional detail, including distance, is needed, reference is made to FIGS. 12 and 13. In one implementation, an example extended depth of field sensor suite 1200 disposed at a distance from an object. The sensor suite 1200 captures a first LWIR image 1204 of the object and a second LWIR image 1206 of the object. The distance of the object corresponding to the first LWIR image 1204 is different from the distance of the object corresponding to the second LWIR image 1206, such that a resolved distance to the object may be analyzed from two disparate distances and perspectives. More particularly, the ISP(s) of the sensor suite 102 may fuse the first LWIR image 1204 and the second LWIR image 1206 and use a disparity in depth of the object between the two to determine the resolved depth through stereo vision, which provides a perception of depth and 3-dimensional structure obtained on the basis of the LWIR data from the different apertures of the sensor suite 1200. Because the apertures of the sensor suite 1200 are located at different lateral positions on the vehicle, the first LWIR image 1204 and the second LWIR image 1206 are different. The differences are mainly in the relative horizontal position of the object in the two images 1204-1206. These positional differences are referred to as horizontal disparities and are resolved through processing by the ISPs by fusing the images and extracting thermal energy values to confirm the object is the same in both images and to provide a coarse distance in extended depth of focus.

As shown in FIG. 13, the first LWIR image 1204 may be a first grid 1400 of pixels (e.g., a two by two gird), and the second LWIR image 1206 may also be a second grid 1402 of pixels (e.g, a two by two grid) that may be fused into a fused grid 1404. The first grid 1400 may indicate an object with a location in the field of view corresponding to a first pixel in the grid 1400, and the second grid 1402 may indicate an object with a location in the field of view corresponding to a second pixel in the grid 1402. The grids 1400-1402 are fused into the fused grid 1404, and thus, the spatial extent of the object is the two pixels 1-2 in the grid 1404. The ISP(s) thus determine that image went from one pixel to two pixels.

To determine whether the pixels in the grid 1404 correspond to the same object with a horizontal disparity or different objects, the fused image is multiplied with a matrix of unique detection features to determine how similar the fused image is to reference thermal parameters, such as emissivity and temperature, indicating what an object is as a function of distance. Using this information, the ISP(s) confirm whether the object is the same across the images 1204-1206 and resolve the horizontal disparity based on the known distance between the corresponding LWIR apertures to provide a resolved image and distance to the object through stereo processing. Thus, in addition to spatial resolution, the presently disclosed technology is providing different perspectives to resolve objects at different depths.

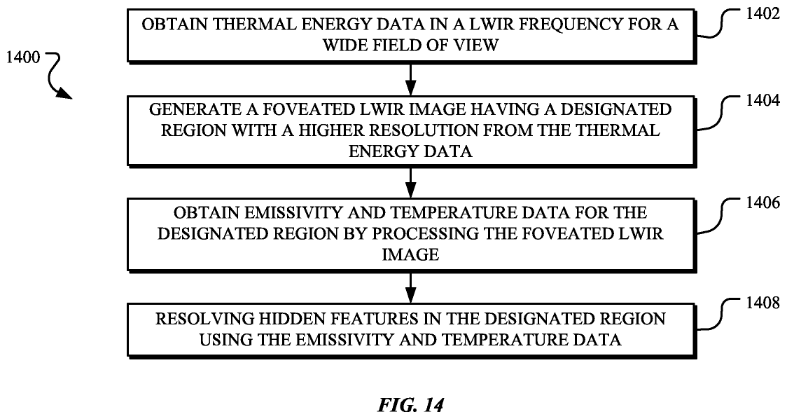

FIG. 14 illustrates example operations 1400 for object detection. In one implementation, an operation 1402 obtains thermal energy data in a long wavelength infrared band for a wide field of view. The long wavelength infrared band may correspond to a wavelength ranging from approximately 8-15 μm and a frequency of approximately 20-37 THz. The thermal energy data may be captured using at least one long wavelength infrared sensor of a sensor suite mounted to a vehicle.

In one implementation, an operation 1404 generates a foveated long wavelength infrared image from the thermal energy data. The foveated long wavelength infrared image has a higher resolution concentrated in a designated region of the wide field of view and a lower resolution in a remaining region of the wide field of view. For example, the designation region may include extremities of the wide field of view and the remaining region may include a center of the wide field of view. In another example, the designation region includes a center of the wide field of view and the remaining region includes extremities of the wide field of view.

An operation 1406 obtains emissivity and temperature data for the designated region by processing the foveated long wavelength infrared image, and an operation 1408 resolves one or more hidden features in the designated region using the emissivity and temperature data. The one or more hidden features may correspond to an object obscured by glare, an object with diminished visibility caused by adverse light conditions, and/or the like. In one implementation, the operation 1408 determines that the one or more hidden features correspond to a moving object based on a change in the emissivity and temperature data from the foveated long wavelength infrared image to a second foveated long wavelength infrared image. In another implementation, the operation 1408 detects and identifies an object in the designated region. The object may be identified based on a thermal profile generated from the emissivity and temperature data. For example, the object may be identified through a comparison of the thermal profile with one or more reference thermal profiles. Alternatively or additionally, the object may be identified by discriminating the emissivity and temperature data according to a relationship of at least one of emissivity or temperature with distance.

In one implementation, an extended depth of field is generated for the one or more hidden features. For example, the extended depth of field may be generated by fusing the foveated long wavelength infrared image with a second foveated long wavelength infrared image. The second foveated long wavelength infrared image represents a perspective and a distance to the one or more hidden features that are different from the first foveated long wavelength infrared image.

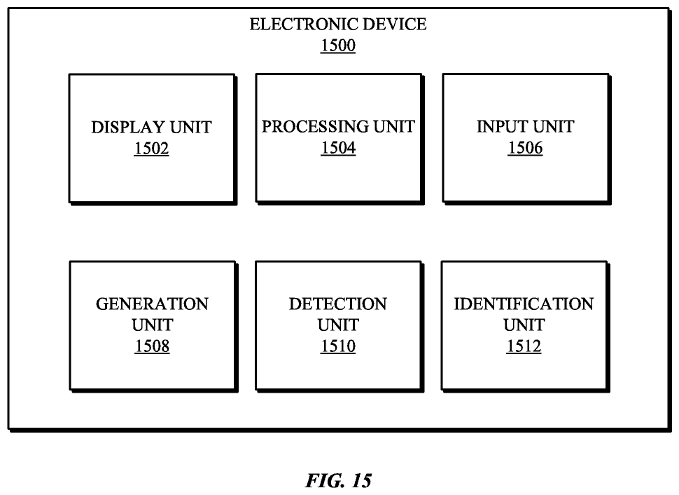

Turning to FIG. 15, an electronic device 1500 including operational units 1502-1512 arranged to perform various operations of the presently disclosed technology is shown. The operational units 1502-1512 of the device 1500 are implemented by hardware or a combination of hardware and software to carry out the principles of the present disclosure. It will be understood by persons of skill in the art that the operational units 1502-1512 described in FIG. 15 may be combined or separated into sub-blocks to implement the principles of the present disclosure. Therefore, the description herein supports any possible combination or separation or further definition of the operational units 1502-1512.

In one implementation, the electronic device 1500 includes a display unit 1502 to display information, such as a graphical user interface, and a processing unit 1504 in communication with the display unit 1502 and an input unit 1506 to receive data from one or more input devices or systems, such as the various sensor suites described herein. Various operations described herein may be implemented by the processing unit 1504 using data received by the input unit 1506 to output information for display using the display unit 1502.

Additionally, in one implementation, the electronic device 1500 includes a generation unit 1508, a detection unit 1510, and an identification unit 1512. The input unit 1506 obtains thermal energy data in a long wavelength infrared frequency for a wide field of view. The generation unit 1508 generates a foveated long wavelength infrared image from the thermal energy data. The foveated long wavelength infrared image has a higher resolution concentrated in a designated region of the wide field of view and a lower resolution in a remaining region of the wide field of view. The detection unit 1510 detects a presence of an object with diminished visibility based on emissivity and/or temperature of the thermal energy data exceeding a threshold in the designated region. The identification unit 1512 identifies the object based on a thermal profile generated from the thermal energy data. In another implementation, the electronic device 1500 includes units implementing the operations described with respect to FIG. 14.

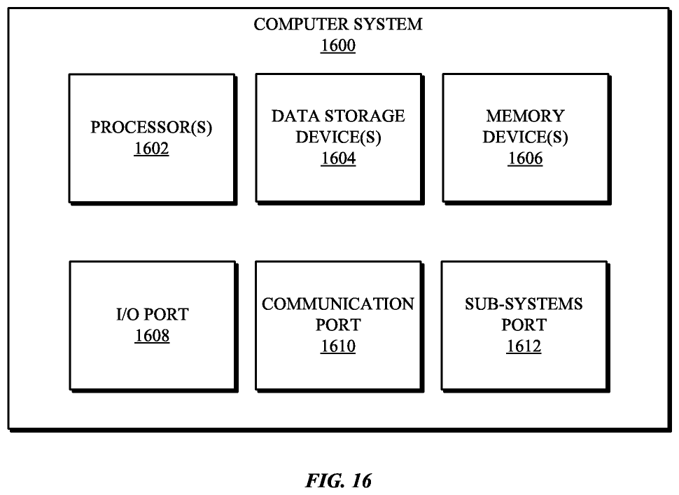

Referring to FIG. 16, a detailed description of an example computing system 1600 having one or more computing units that may implement various systems and methods discussed herein is provided. The computing system 1600 may be applicable to the image signal processor, the sensor suite, the vehicle controller, and other computing or network devices. It will be appreciated that specific implementations of these devices may be of differing possible specific computing architectures not all of which are specifically discussed herein but will be understood by those of ordinary skill in the art.

The computer system 1600 may be a computing system is capable of executing a computer program product to execute a computer process. Data and program files may be input to the computer system 1600, which reads the files and executes the programs therein. Some of the elements of the computer system 1600 are shown in FIG. 16, including one or more hardware processors 1602, one or more data storage devices 1604, one or more memory devices 1608, and/or one or more ports 1608-1612. Additionally, other elements that will be recognized by those skilled in the art may be included in the computing system 1600 but are not explicitly depicted in FIG. 16 or discussed further herein. Various elements of the computer system 1600 may communicate with one another by way of one or more communication buses, point-to-point communication paths, or other communication means not explicitly depicted in FIG. 16.

The processor 1602 may include, for example, a central processing unit (CPU), a microprocessor, a microcontroller, a digital signal processor (DSP), and/or one or more internal levels of cache. There may be one or more processors 1602, such that the processor 1602 comprises a single central-processing unit, or a plurality of processing units capable of executing instructions and performing operations in parallel with each other, commonly referred to as a parallel processing environment.

The computer system 1600 may be a conventional computer, a distributed computer, or any other type of computer, such as one or more external computers made available via a cloud computing architecture. The presently described technology is optionally implemented in software stored on the data stored device(s) 1604, stored on the memory device(s) 1606, and/or communicated via one or more of the ports 1608-1612, thereby transforming the computer system 1600 in FIG. 16 to a special purpose machine for implementing the operations described herein. Examples of the computer system 1600 include personal computers, terminals, workstations, mobile phones, tablets, laptops, personal computers, multimedia consoles, gaming consoles, set top boxes, and the like.

The one or more data storage devices 1604 may include any non-volatile data storage device capable of storing data generated or employed within the computing system 1600, such as computer executable instructions for performing a computer process, which may include instructions of both application programs and an operating system (OS) that manages the various components of the computing system 1600. The data storage devices 1604 may include, without limitation, magnetic disk drives, optical disk drives, solid state drives (SSDs), flash drives, and the like. The data storage devices 1604 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1606 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1604 and/or the memory devices 1606, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 1600 includes one or more ports, such as an input/output (I/O) port 1608, a communication port 1610, and a sub-systems port 1612, for communicating with other computing, network, or vehicle devices. It will be appreciated that the ports 1608-1612 may be combined or separate and that more or fewer ports may be included in the computer system 1600.

The I/O port 1608 may be connected to an I/O device, or other device, by which information is input to or output from the computing system 1600. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 1600 via the I/O port 1608. Similarly, the output devices may convert electrical signals received from computing system 1600 via the I/O port 1608 into signals that may be sensed as output by a human, such as sound, light, and/or touch. The input device may be an alphanumeric input device, including alphanumeric and other keys for communicating information and/or command selections to the processor 1602 via the I/O port 1608. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 1600 via the I/O port 1608. For example, an electrical signal generated within the computing system 1600 may be converted to another type of signal, and/or vice-versa. In one implementation, the environment transducer devices sense characteristics or aspects of an environment local to or remote from the computing device 1600, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 1600, such as, physical movement of some object (e.g., a mechanical actuator), heating or cooling of a substance, adding a chemical substance, and/or the like.

In one implementation, a communication port 1610 is connected to a network by way of which the computer system 1600 may receive network data useful in executing the methods and systems set out herein as well as transmitting information and network configuration changes determined thereby. Stated differently, the communication port 1610 connects the computer system 1600 to one or more communication interface devices configured to transmit and/or receive information between the computing system 1600 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 1610 to communicate one or more other machines, either directly over a point-to-point communication path, over a wide area network (WAN) (e.g., the Internet), over a local area network (LAN), over a cellular (e.g., third generation (3G), fourth generation (4G), or fifth generation (5G)) network, or over another communication means. Further, the communication port 1610 may communicate with an antenna or other link for electromagnetic signal transmission and/or reception. In some examples, an antenna may be employed to receive Global Positioning System (GPS) data to facilitate determination of a location of a machine, vehicle, or another device.

The computer system 1600 may include a sub-systems port 1612 for communicating with one or more systems related to a vehicle to control an operation of the vehicle and/or exchange information between the computer system 1600 and one or more sub-systems of the vehicle. Examples of such sub-systems of a vehicle, include, without limitation, imaging systems, radar, LIDAR, motor controllers and systems, battery control, fuel cell or other energy storage systems or controls in the case of such vehicles with hybrid or electric motor systems, autonomous or semi-autonomous processors and controllers, steering systems, brake systems, light systems, navigation systems, environment controls, entertainment systems, and the like.

In an example implementation, object detection information, reference thermal profiles, calibration data, and software and other modules and services may be embodied by instructions stored on the data storage devices 1604 and/or the memory devices 1606 and executed by the processor 1602. The computer system 1600 may be integrated with or otherwise form part of a vehicle. In some instances, the computer system 1600 is a portable device that may be in communication and working in conjunction with various systems or sub-systems of a vehicle.

The present disclosure recognizes that the use of such information may be used to the benefit of users. For example, the location information of a vehicle may be used to provide targeted information concerning a “best” path or route to the vehicle and to avoid objects. Accordingly, use of such information enables calculated control of an autonomous vehicle. Further, other uses for location information that benefit a user of the vehicle are also contemplated by the present disclosure.

Users can selectively block use of, or access to, personal data, such as location information. A system incorporating some or all of the technologies described herein can include hardware and/or software that prevents or blocks access to such personal data. For example, the system can allow users to “opt in” or “opt out” of participation in the collection of personal data or portions thereof. Also, users can select not to provide location information, or permit provision of general location information (e.g., a geographic region or zone), but not precise location information.

Entities responsible for the collection, analysis, disclosure, transfer, storage, or other use of such personal data should comply with established privacy policies and/or practices. Such entities should safeguard and secure access to such personal data and ensure that others with access to the personal data also comply. Such entities should implement privacy policies and practices that meet or exceed industry or governmental requirements for maintaining the privacy and security of personal data. For example, an entity should collect users' personal data for legitimate and reasonable uses and not share or sell the data outside of those legitimate uses. Such collection should occur only after receiving the users' informed consent. Furthermore, third parties can evaluate these entities to certify their adherence to established privacy policies and practices.

The system set forth in FIG. 16 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for object detection, the method comprising:
obtaining thermal energy data in a long wavelength infrared (LWIR) band with a wavelength ranging from 8-15 μm for a field of view, the thermal energy data captured using at least one LWIR sensor of a vehicle;
generating a foveated LWIR image from the thermal energy data, the foveated LWIR image having a first resolution concentrated in one or more designated regions of the field of view and a second resolution in a remaining region of the field of view, the first resolution being higher than the second resolution;
obtaining emissivity and temperature data for the one or more designated regions by processing the foveated LWIR image; and
resolving one or more features in the one or more designated regions using the emissivity and temperature data.

2. The method of claim 1, wherein the one or more designated regions includes extremities of the field of view and the remaining region includes a center of the field of view.

3. The method of claim 1, wherein the one or more designated regions includes a center of the field of view and the remaining region includes extremities of the field of view.

4. The method of claim 1, wherein resolving the one or more features includes determining that the one or more features correspond to a moving object based on a change in the emissivity and temperature data from the foveated LWIR image to a second foveated LWIR image.

5. The method of claim 1, wherein resolving the one or more features includes detecting and identifying an object in the one or more designated regions.

6. The method of claim 5, wherein the object is identified based on a thermal profile generated from the emissivity and temperature data.

7. The method of claim 6, wherein the object is identified through a comparison of the thermal profile with one or more reference thermal profiles.

8. The method of claim 5, wherein the object is identified by discriminating the emissivity and temperature data according to a relationship of at least one of emissivity or temperature with distance.

9. The method of claim 1, wherein the one or more features correspond to an object obscured by glare.

10. The method of claim 1, wherein the one or more features correspond to an object with diminished visibility caused by adverse light conditions.

11. The method of claim 1, wherein a depth of field is extended for the one or more features.

12. The method of claim 11, wherein the depth of field is extended by fusing the foveated LWIR image with a second foveated LWIR image, the second foveated LWIR image representing a perspective and a distance to the one or more features that are different from the first foveated LWIR image.

13. A system for object detection, the system comprising:
one or more sensors mounted to a vehicle, the one or more sensors including at least one long wavelength infrared (LWIR) sensor, the at least one LWIR sensor capturing thermal energy in a LWIR band for a field of view; and
an image signal processor resolving an object with diminished visibility in the field of view using emissivity and temperature data obtained from a foveated LWIR image, the foveated LWIR image having a first resolution concentrated in one or more designated regions of the field of view and a second resolution in a remaining region of the field of view, the first resolution being higher than the second resolution, the one or more designated regions including the object.

14. The system of claim 13, further comprising:
a vehicle controller executing at least one vehicle operation in response to the object being resolved.

15. The system of claim 14, wherein the at least one vehicle operation includes at least one of: presenting a notification of a presence of the object; controlling a direction of travel of the vehicle to avoid the object; slowing a speed of the vehicle; or directing at least one light source towards the one or more designated regions to illuminate the object.

16. The system of claim 13, wherein the one or more sensors further includes at least one of a monochromatic sensor or a light detection and ranging sensor that are co-boresight with the at least one LWIR sensor.

17. The system of claim 13, wherein the one or more sensors further includes one or more first sensors and one or more second sensors, the one or more first sensors having a first effective focal length of 35 mm or less, and the one or more second sensors having a second effective focal length of 85 mm or more.

18. The system of claim 13, wherein the image signal processor determines a distance to the object by extending a range of distance over which the object remains in focus.

19. One or more non-transitory computer-readable data storage media comprising instructions that, when executed by at least one computing unit of a computing system, cause the computing system to perform operations comprising:
obtaining thermal energy data in a long wavelength infrared (LWIR) band for a field of view;
generating a foveated LWIR image from the thermal energy data, the foveated LWIR image having a first resolution concentrated in one or more designated regions of the field of view and a second resolution in a remaining region of the field of view, the first resolution being higher than the second resolution;
detecting a presence of an object with diminished visibility based on at least one of emissivity or temperature of the thermal energy data exceeding a threshold in the one or more designated regions;
identifying the object based on a thermal profile generated from the thermal energy data.

20. The one or more non-transitory computer-readable data storage media of claim 19, wherein the object is identified based on a comparison of the thermal profile to one or more reference thermal profiles.
